(19) United States
(12) Patent Application Publication
(10) Pub. No.: US 2004/0018309 A1
(43) Pub. Date: Jan. 29, 2004

(54) Furnace parts protected by thermally and chemically resistant coatings

(75) Inventor: James W. Otter, Fairfield Glade, TN (US)

Correspondence Address: WALL MARJAMA & BILINSKI, 101 SOUTH SALINA STREET, SUITE 400, SYRACUSE, NY, 13202, US

(73) Assignee: Carrier Corporation

(21) Appl. No.: 10/205,069

(22) Filed: Jul. 25, 2002

(51) Int. Cl. B05D 3/02; B05D 1/36

(52) U.S. Cl. 427/385.5; 427/407.1

(57) ABSTRACT

In the present invention a coating is applied to metal to protect it against the thermal and chemical stresses encountered by furnace parts exposed to flue vent gases and their condensate. The materials forming the coating materials may be thermosetting or thermoplastic polymers, in any form from monomeric through polymeric, with or without reactive moieties. The coating may be applied as aqueous or non-aqueous dispersions or solutions or in powder form, or vapor or vacuum deposited. The system provides a coating which is thermally and chemically resistant and which generates a low level of VOC's.

### FIELD OF THE INVENTION

The invention relates to metal surfaces which are used for furnace parts, and more specifically to thermally and chemical resistant coatings for such parts.

### BACKGROUND OF THE INVENTION

There has been a continuing need in the field for a reduction in corrosion and cost of metals exposed to flue vent gas in furnaces, and to an improvement in the robustness of condensing furnace secondary heat exchanger material.

To date, no commercially viable coatings are able to withstand performance test standards used to evaluate materials used to make condensing furnace secondary heat exchanger material. Such coatings have to be exceptionally thermally and chemically resistant, and form a barrier so protective that lengthy exposure to condensing steam and acidic flue vent gases will not affect the metal, nor their bond to that metal. They must also withstand the heat, acids and moisture found in furnace parts exposed to flue gases.

Conventional metals used to make condensing furnace secondary heat exchanger cells require a chemically and thermally resistant protective coating. EPDM molded parts withstand flue gas condensate at room temperature. Ethylene-propylene copolymer film is being currently being used in condensing furnace heat exchangers. Conventionally a phenolic primer is formed on the metal surface which is then laminated with an ethylene-propylene film up to about 6 mils in thickness. These requires complex processing which is expensive, and generates unwanted VOC's.

### SUMMARY OF THE INVENTION

It is therefore an object of the present invention to provide a protective coating for furnace heat exchanger material which overcomes the problems of the prior art described above.

It is further object of the present invention to provide an improved protective coating for metal surfaces which are used in furnace components.

It is yet another object of the present invention to provide a corrosion resistant coating which is receptive to chemical bonding with a protective overlayer.

It is yet another object of the present invention to provide composite coating system for a metal surface which is low in VOC generation, and which can be efficiently and economically produced.

It is a further object of the present invention to provide a coating system for furnace parts which provides for thermal and chemical resistance.

In the present invention a coating is applied to metal to protect it against the thermal and chemical stresses encountered by furnace parts exposed to flue vent gases and their condensate. The materials forming the coating materials may be thermosetting or thermoplastic polymers, in any form from monomeric through polymeric, with or without reactive moieties. The coating may be applied as aqueous or non-aqueous dispersions or solutions, or in powder from, or vapor or vacuum deposited.

In one embodiment, a cold rolled galvanized steel is treated with a phosphate-chromate solution to chemically pacify the surface. The surface is then rinsed and dried. A coating of a phenolic primer is then applied to the surface and then cured for from three (3) t thirty (30) seconds. A thermoplastic or thermosetting polymer layer is then applied over the cured primer layer. The polymer layer is then cured for from three (3) to thirty (30) seconds. In this method the polymer is a material selected from the group of fluorocarbons, silicones, EPDM, urethanes, epoxies, polyesters, polyimides and phenolic resins. The top coating may range in thickness from about 0.1 to 4 mils.

In a preferred aspect of this embodiment, to improve abrasion resistance, cost, and to reduce the likelihood of voids in the coating, a coating of one (1) to six (6) mils in thickness is applied in a continuous operation by the following method:

1. The surface of a strip of cold rolled galvanized steel is cleaned and dried,

2. A layer of high solids content EPDM non-aqueous dispersion is applied and cured for from ten (10) seconds to two (2) minutes. The preferred EPDM nonaqueous dispersion contains reactive acrylic monomers, especially acrylic acid and suitable esters thereof, to effect and/or improve adhesion, and is peroxide cured to effect rapid cure; it also contains phenolic monomers and/or resins to effect and/or improve adhesion, and to improve chemical and thermal properties.

### BRIEF DESCRIPTION OF THE DRAWINGS

For a further understanding of these and objects of the invention, reference will be made to the following detailed description of the invention which is to be read in connection with the accompanying drawing, wherein:

FIG. 1 is a side sectional view of a composite protective coating for use on metal substrates which are used for furnace components.

FIG. 2 is a schematic flow diagram illustrating one embodiment of a method of coating metal to be used as a furnace component.

### DETAILED DESCRIPTION OF THE INVENTION

A coating is applied to metal to protect it against the thermal and chemical stresses encountered by furnace parts exposed to flue vent gases and their condensate.

The materials forming the coating materials may be thermosetting or thermoplastic polymers, in any form from monomeric through polymeric, with or without reactive moieties. They may be applied as aqueous or non-aqueous dispersions or solutions, or in powder from, or vapor or vacuum deposited. Fluorocarbon, silicone, EPDM, urethane, epoxy, polyester, polyimide and phenolic resins are among those that might be used.

For reasons of cost and efficiency, the coating method for aqueous or non-aqueous dispersions or solutions is likely to be tandem coating of coils of metal in a continuous process, but need not be limited to that method. The chief advantage of this method is the over coating of holes, inclusions, blisters and like flaws in the first coating. This approach would be most useful with coatings flexible enough to allow post-forming of the metal into furnace parts. A coating with limited flexibility and/or adhesion would be applied to the formed parts by dip, spray or like methods.

A powder may be applied by (electrostatic) spray or a gravimetric method, and the point of application in the process of making a heat exchanger would be decided by the coating's properties.

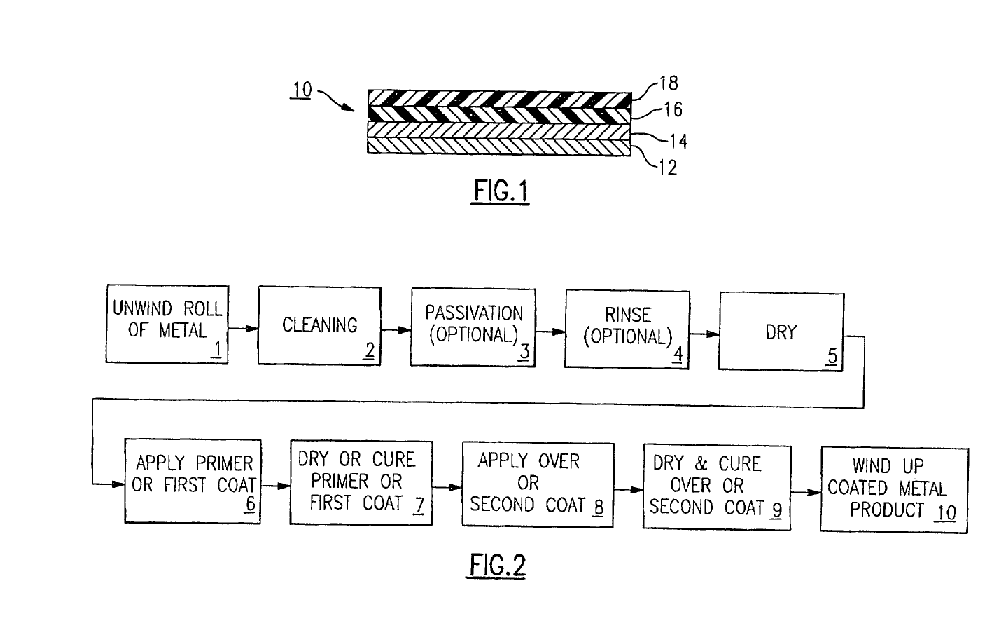

FIG. 1 illustrates a side sectional view of a composite thermally and chemically resistant coating for a metal component for use in a heat exchanger. The composite 10 comprise a metal substrate 12, a passivation film 14, a primer coating 16 and a thermally and chemically resistant coating 18.

In one embodiment of the present application, a roll of metal is coated with a primer or a first coat, then overcoated to make the desired product a corrosion-resistant strip of metal with the desired chemically and thermally resistant properties. Here, both operations are by roll coating, using a liquid coating solution, aqueous or non-aqueous. Powder application may be substituted for either or both roll coating operations, as may other methods of applying the coating material. Passivation of the metal, and therefore the subsequent dependent steps, is optional.

Referring to FIG. 2 of the drawings a roll of metal of the desired alloy, thickness and width is unrolled and pulled along the path described. The surface of the metal is then (chemically) cleaned. At the third station optional (chemical) passivation of the metal surface occurs. If the surface is (chemically) passivated, then the fourth station excess passivating chemicals are rinsed off, and at the fifth station the (passivated) surface is dried, else the operations at stations 3 and 4 are omitted, but station 5 is retained to dry the surface wetted by cleaning.

At station 6, the primer or first coat is applied. It may be applied by any commercial method. At station 7, the primer coat or first coat is dried or cured. At station 8, the over or second coat is applied by any commercial method. At station 9, the over or second coat is dried or cured. At station 10, the coated metal product is would up.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A method of forming a protective coating on a metal substrate which comprises:
(a) providing a metal substrate having a surface to be coated;
(b) cleaning said substrate;
(c) applying a primer coating to said substrate; and
(d) applying a thermally and chemically resistant coating over said primer coating with said primer being at least one material selected from the group consisting of a fluorocarbon, silicone, EPDM, urethane, epoxy, polyester, polyimide and phenolic resins.

2. The method of claim 1 in which the metal substrate is one selected from the group consisting of steel, aluminum and copper.

3. The method of claim 1 in which the coatings are applied by aqueous or non-aqueous dispersions, solutions, powder, vapor or vacuum.

4. The method of claim 1 in which the substrate is chemically passivated following the cleaning in step (b).

5. The method of claim 1 in which the coating is an EPDM non-aqueous dispersion which contains reactive acrylic monomers, especially acrylic acid and suitable esters thereof, to effect and/or improve adhesion, and is peroxide cured to effect rapid cure; it further contains phenolic monomers and/or resins to effect and/or improve adhesion, and to improve chemical and thermal properties.

6. The method of claim 5 in which the coating is single layer absent a prime coat.

7. The method of claim 5 in which the coating is an EPDM non-aqueous dispersion which contains reactive acrylic monomers, especially acrylic acid and suitable esters thereof, to effect and/or improve adhesion, and is peroxide cured to effect rapid cure; it also contains phenolic monomers and/or resins to effect and/or improve adhesion, and to improve chemical and thermal properties.

8. The method of claim 6 in which the coating is an EPDM non-aqueous dispersion which contains reactive acrylic monomers, especially acrylic acid and suitable esters thereof, to effect and/or improve adhesion, and is peroxide cured to effect rapid cure; it also contains phenolic monomers and/or resins to effect and/or improve adhesion, and to improve chemical and thermal properties.
